(19) United States
(12) Patent Application Publication
(10) Pub. No.: US 2004/0212698 A1
(43) Pub. Date: Oct. 28, 2004

(54) Method and device for image management and image management system

(75) Inventor: Eiichi Kito, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/673,395

(22) Filed: Sep. 30, 2003

(30) Foreign Application Priority Data
Sep. 30, 2002 (JP) 287354/2000

(51) Int. Cl. H04N 5/262

(52) U.S. Cl. 348/231.99

(57) ABSTRACT

In a system storing data of pictures taken by a digital camera, data to be deleted is recorded on a recording medium before deleting the stored data, and the data is returned to the customers in a state in which the customers can easily utilize and organize the data. An image database 12 for accumulating and storing photographic image data 100 is provided. The photographic image data 100 obtained by using digital cameras is received from the customers and stored in the image database 12 in a state where the customer can access the data. The photographic image data 100 accumulated and stored in the image database 12 is judged whether storage period thereof is terminated. Moreover, expired photographic image data 100 is recorded onto a recording medium by a storage recording device 14.

### BACKGROUND OF THE INVENTION

1. Field of the Invention

The present invention relates to a management device for photographic image data, which temporarily stores photographic image data taken by digital cameras in a large capacity disk of a server computer owned by a photo studio or the like and returns expired photographic image data, for which a storage period has expired, to customers in a manner that enables the customers to easily utilize and organize the photographic image data.

2. Description of the Related Art

Image storage services have been conventionally known as a digital photography service. In the image storage service, photographic image data received from customers is stored in a system owned by a service provider such as a photo studio or a photographic laboratory, and print orders are received through a network such as the Internet.

In this service, the photographic image data received from the customers is stored in the system owned by the service provider, and further, is accessible through a password on the network. The customers are able to browse the stored photographic image data by accessing the system owned by the service provider through the network and to place print orders for the stored photographic image data. (e.g., refer to U.S. Pat. No. 6,337,712)

Moreover, since the system which offers the service has a limit to the capacity of the image server storing the photographic image data, the system is created to delete the photographic image data after a certain period of time has passed. Thus, there is a system created to delete the expired photographic image data automatically, even responding to a change in a storage period, to make things easier for a system administrator and an operator. (e.g., refer to Japanese Unexamined Patent Publication No. 11 (1999)-203360)

The foregoing image storage service is only a temporary measure for the customers who requested the image storage. To store photographic images for a long period of time to utilize and organize, the customers have had to separately store the photographic images on their own. Thus, there has been a disadvantage that the customers had to doubly store and manage their photographic image data. Moreover, as the number of photography operations by the digital cameras increases, the number of photographic images is increased. Therefore, the utilization and organization of the photographic image data have a tendency to become further troublesome.

### SUMMARY OF THE INVENTION

In consideration of the foregoing problems, an object of the present invention is to provide a system in which photographic images taken by digital cameras are temporarily stored and the stored photographic images are returned to the customers in a form that enables the customers to easily utilize and organize the images.

An image management device of the present invention is characterized by including an image storage unit, an image receiving unit, an image storage expiration determining unit and a storage recording unit. The image storage unit accumulates and stores photographic image data. The image receiving unit receives the photographic image data from customers and stores the photographic image data in the image storage unit in a state so that the data is accessible to the customers, along with customer data related to the customers. The image storage expiration determining unit determines whether to expire the storage period of the photographic image data accumulated and stored in the image storage unit. The storage recording unit records the photographic image data for which the storage period has been determined to be expired by the image storage expiration determining unit on a storage recording medium.

Herein, the “image, storage unit” is a computer (e.g., a server computer) including communication functions installed at a photographic shop laboratory or a service center. The computer is provided with a data storage device such as a hard disk having enough capacity required to manage digital images and sufficient for storing the photographic image data.

Moreover, “store in a state accessible to the customers” means that the data is stored to be accessible to the customers. Thus, the customers can be provided with a variety of photo services; each customer is able to browse, retrieve and download the stored photographic image data; the customers can place print orders for the photographic image data, output the data to a storage medium such as a DVD and transfer the data to a designated address. More specifically, the customers can access the data from a reception terminal at a store, personal computers, portable terminals, mobile phones and the like.

That the image receiving unit “stores the photographic image data . . . along with customer data related to the customers” refers to storing data that enables specification of a customer who has stored the photographic image data. The customer data is stored in such a manner so that data regarding the customer who performed storage of the photographic image data is obtainable.

In addition, “determine whether to expire the storage period of the photographic image data” means to determine whether the photographic image data has reached a certain condition, including: the storage period of the data has expired; the number of stored images has reached a predetermined number; and a used capacity of the server has reached a predetermined capacity.

Further, “the storage recording medium” is preferably portable, including optical storage media such as a DVD and a CD-RW and memory storage media such as “smart media” (registered trademark), a “memory stick” (registered trademark) and memory cards. The storage recording medium can be given to the customers via mail or at the store and the like.

The image management device sometimes receives the same photographic image data repeatedly upon reception of the photographic image data. Accordingly, the image receiving unit preferably determines whether the received photographic image data has already been received before based on additional information attached to the photographic image data and receives only the photographic image data that has not already been received.

Herein, the “additional information” is information attached to each photographic image data, including a file name, received information (information indicating that the photographic image data has already been received), a photography date and a previous read-out date. The process of “judging whether the photographic image data has already been received based on the additional information” is to make a judgment if the photographic image data has already been received including: comparing file names; checking whether the received information is attached to the photographic image data; comparing the photography date with the previous read-out date.

Moreover, the photographic image data is sometimes received far from the place where the image storage unit is placed.

Accordingly, the image receiving unit may transfer and store the received photographic image data in the image storage unit through the network.

By “transfer to the image storage unit through the network” means that the data is transferred to the image storage unit through a variety of networks. For example, the photographic image data is transferred to the image storage unit from digital cameras, personal computers and portable terminals utilizing a wireless LAN Internet connection; the photographic image data is transferred to the image storage unit through the Internet from mobile phone services such as i-mode and J-SKY; and the photographic image data received by the receiver is transferred to the image storage unit utilizing a VPN (Virtual Private Network), a dedicated line, the Internet, Point-to-Point and the like. Alternatively, the photographic image data is transferred from home personal computers and the like utilizing various networks such as the Internet, a CATV network, a dial-up connection and the like.

The image storage expiration determining unit may determine the storage expiration for each pre-classified photographic image data group.

A “pre-classified photographic image data group” is photographic image data classified into groups (e.g., travel and growth record) designated by the customers.

Moreover, the storage recording unit associates a plurality of photographic image data and specifies the photographic image data that represents the associated photographic image data. The storage recording unit records the photographic image data on the storage recording medium to make the associated photographic image data reproducible during replay by selecting the representative photographic image data.

This “representative photographic image data” acts as an index of the photographic image data when the plurality of the photographic image data is associated to be managed. “The associated photographic image data can be reproduced during replay by selecting the representative photographic image data” means that, when replay equipment such as a personal computer reproduces photographic image data, the selection of the representative photographic image data enables the associated managed photographic image data to be read out. For example, photographic image data of similar scenes is managed as a group, and representative photographic image data is selected. Thereupon, the photographic image data of other similar scenes can be reproduced. The photographic image data is not limited to the similar scenes. The photographic image data can be related to travel or a growth record.

The storage recording unit may record the photographic image data onto the storage recording medium by associating the photographic image data with additional information related to the photographic image data.

The “additional information” is information related to the images. Examples of the additional information are names of the places and buildings obtained from GPS data, descriptions thereof, and coeval information on current events (image, description) obtained from date information.

Herein, as previously mentioned, the expired photographic image data can be deleted from the image storage unit such as a computer after being recorded onto the storage recording medium. However, occurrence of defects is assumed when the data is recorded onto the storage recording medium.

Therefore, the image storage unit may delete the photographic image data, which has been recorded onto the storage recording medium by the storage recording unit, from the image storage unit after the photographic image data is stored in the image storage unit for a predetermined period in an inaccessible state to the customers.

The “inaccessible state to the customers” means the state in which the customers cannot provide their stored photographic image data to the photo service. However, an administrator or the like of the server computer storing the photographic image data can access the data. When there are defects in the photographic image data recorded onto the storage recording medium, the photographic image data can be re-recorded onto the storage recording medium.

Additionally, when the photographic image data is recorded onto the storage recording medium, the system may further include a printing unit which prints an index print of the photographic image data. Herein, the index print also includes an address print.

The printing unit has selecting means for selecting desired photographic image data from among the photographic image data recorded onto the storage recording medium. The index print is preferably created for only the photographic image data selected by the selecting unit.

The “selected photographic image data” includes photographic image data selected by a selection method wherein the aforementioned representative photographic image data are selected, photographic image data with a constant frame interval are selected, photographic image data in which several displayable frames are selected from among all the frames, and photographic image data related to photography dates, selected from frames arranged by photography dates or the same photography date are selected.

In addition, it is preferable that the image management device further comprise:

a checking unit for checking customer data recorded in the storage recording medium against the customer data stored along with the image data sets accumulated in the image storage unit, when additional image data sets are to be recorded into the storage recording medium in which image data sets of a predetermined customer are already stored by the storage recording unit; wherein

the storage recording unit records the image data sets for which the customer data checked by the checking unit match, in the storage recording medium.

The image management system of the present invention connects the image management device of the present invention and user terminals through the network. The image management system of the present invention is characterized by that the image storage expiration determining unit includes a storage expiration notifying unit which notifies the user terminals of storage expiration of photographic image data that are determined to be deleted from storage.

A variety of networks including the Internet, CATV networks, dial-up connections, LAN's and WAN's can be utilized as the “network.” Moreover, the “user terminals” are personal computers, portable terminals, mobile phones, and the like. “Notify the user terminals of storage expiration” is performed by e-mails or the like which can make the customers recognize storage expiration.

The storage expiration notifying unit may further notify the user terminals of customers who have permission to view the plurality of photographic image data sets, of storage expiration of the plurality of image data sets which have been determined to be expired.

“Permission to view the plurality of photographic image data sets” refers to a state in which photographic image data sets, posted on a Web page or the like, are enabled to be viewed via a network.

The storage recording unit may record onto the storage recording medium via a network.

“Record onto the storage recording medium via a network” refers to, for example, connecting a recording apparatus installed at a storefront or a recording apparatus connected to a PC in a user's home via a network; transmitting the photographic image data sets via the network; and employing the recording apparatus, which is connected to the network, to record onto the storage recording medium.

Another image management system of the present invention connects a plurality of image management devices of the present invention through a network. The image management system is characterized as follows: the photographic image data has storage information which specifies a predetermined storage location of the photographic image data for the digital cameras and the customers; and the image receiving unit transfers the received photographic image data to a predetermined image management device in accordance with the storage information included in the photographic image data and stores the data in the image storage unit of the image management device.

“Storage information which specifies a predetermined storage location of the photographic image data for the digital cameras and the customers” includes information registered in digital cameras in advance, information registered in digital cameras, which has been transferred to a removable medium, and IDs registered on the customers' cards. The storage information can identify digital cameras and the customers as well as a server computer which stores the photographic image data in accordance with digital cameras and customers.

Further, another image management system of the present invention connects another image management system of the present invention and user terminals through a network. The image management system is characterized by that the image storage expiration determining unit includes a storage expiration notifying unit which notifies the user terminals of storage termination concerning photographic image data determined to be expired from storage.

According to the image management device of the present invention, by determining whether to expire the storage period of the photographic images accumulated in the image storage unit such as a server computer, expired photographic images can be recorded onto a recording medium including a DVD. Accordingly, when the storage period of the photographic image expires, the number of stored images exceeds the predetermined number, or a storage capacity reaches the predetermined capacity, photographic images to be deleted are recorded onto another recording medium automatically. Thus, the photographic images can be returned to the customers. Therefore, the customers are freed from having to store the photographic images in another recording medium before the images are deleted.

In addition, by receiving and reading only the photographic images yet to be received, time to read the images are reduced, and it is possible to prevent duplicate storage and writing into the recording medium.

Determining expiration of the storage period for each pre-classified photographic image data group enables the photographic image data to be returned to the customers so that the customers can easily utilize and organize the photographic image data.

The representative photographic image data of the associated photographic image data is designated and recorded onto a recording medium. Accordingly, related photographic image data such as similar scenes can be reproduced during replay by selecting the representative photographic image data. Moreover, it is difficult to retrieve images from a large-capacity recording medium such as a DVD when there are a great number of similar images. However, this enables facilitated retrieval.

Furthermore, the photographic image data and related additional information are associated and recorded onto a medium. Thus, it is possible to organize the photographic image data easily and record the information related to the images together with the images. Therefore, the medium functions as an album, enhancing the customer's enjoyment.

After the expired photographic image data is recorded onto a medium, the photographic image data is not deleted from the sever computer immediately and is stored for a predetermined period of time in a state which the customers cannot access the photographic image data. Thereafter, the photographic image data is deleted from the image storage unit. In this case, when the customers cannot reproduce the photographic image data properly, due to defects occurring when the data is recorded onto the medium, the data can be re-recorded. Alternatively, when there are accidents such as the medium not being delivered to the customers, it is possible to solve the problems.

The index print of the photographic image is printed when the photographic image data is recorded onto a medium. Accordingly, it is possible to send the index print when the image data is returned to the customers.

In addition, the image management device may adopt a configuration in which customer data recorded in the recording medium is checked when additional photographic image data sets are to be recorded onto a recording medium in which photographic image data sets are already recorded. Thereby, confirmation is made possible as to whether the recording medium is that of a customer who desires to record the additional image data sets. Therefore, additional photographic image data sets are enabled to be recorded in a recording medium belonging to the user, without increasing the number of unnecessary recording mediums.

Regarding the photographic images for which the storage periods expire, the user terminals are notified of the expiration of the storage. Confirmation can be made to the customer, whether it is necessary to extend the storage period, to record the photographic images onto a recording medium such as a DVD, or the like.

Furthermore, predetermined storage information for the digital cameras and customers are provided with the photographic image data. The photographic image data can be transferred to a predetermined image management device, corresponding to the digital cameras or customers.

By transmitting the storage expiration notification not only to the customer who stored the photographic image data sets, but also to customers who have permission to view them, the customers who have permission to view the photographic image data sets are also enabled to transfer them from a storage region to a DVD or the like for storage, if necessary.

Further, by performing recording to the recording medium with a recording apparatus which is installed at a storefront and connected to a network, photographic image data sets for which a storage period has expired can be easily recorded to a recording medium such as a DVD.

### BRIEF DESCRIPTION OF THE DRAWINGS

FIG. 1 is a diagram schematically showing an image management device according to the first embodiment of the present invention.

FIG. 2 is a diagram for explaining the assignment, of representative photographic image data of the related photographic image data.

FIG. 3 is a diagram for explaining the correspondence of additional information to photographic image data.

FIG. 4 is a flow chart for explaining operations when storage termination is judged.

FIG. 5 is a diagram for explaining judgment of storage termination.

FIG. 6 is an example of customer information.

FIG. 7 is a flow chart for explaining operation of creating a storage table.

FIG. 8 is a diagram for explaining determination of the storage period.

FIG. 9 is a diagram schematically showing an image management system according to the second embodiment of the present invention.

FIG. 10 is a flow chart for explaining operations when determining storage termination of the image management system.

FIG. 11 is a diagram schematically showing an image management system according to the third embodiment of the present invention.

FIG. 12 is a diagram schematically showing an image management system according to the fourth embodiment of the present invention.

FIG. 13 is a diagram schematically showing an image management system according to the fifth embodiment of the present invention.

### DESCRIPTION OF THE PREFERRED EMBODIMENTS

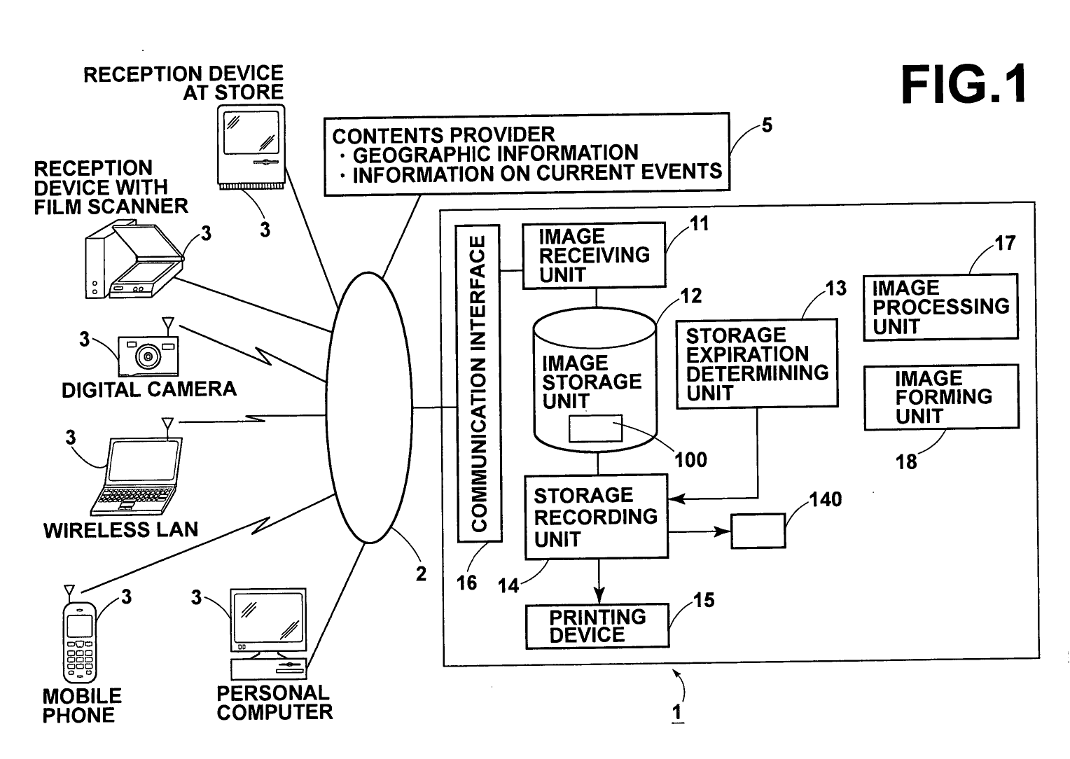

The image management device of the present invention is detailed below with reference to the drawings. FIG. 1 is a diagram schematically showing an image management device 1 according to the first embodiment of the present invention. As shown in FIG. 1, the image management device 1 is installed in a photographic shop laboratory, a service center or the like. The image management device 1 is a server computer equipped with communication functions and storage devices such as a large-capacity hard disk. The image management device 1 is constituted of an image receiving unit 11, an image storage unit 12, an image storage termination determining unit 13, a storage recording unit 14, a printing unit 15, communication interface 16 and the like. The image receiving unit 11 accepts photographic image data 100. The image storage unit 12 stores the accepted photographic image data 100. The image storage termination determining unit 13 judges whether the storage of the photographic image data 100 accumulated in the image storage unit 12 should be terminated. The storage recording unit 14 stores the storage-terminated photographic image data 100 in the storage recording medium 140. The printing unit 15 prints an index print of the photographic image data 100 recorded on the storage recording medium 140. The communication interface 16 and the like is connected to a transmission network 2 for the photographic image data 100.

Moreover, the image management device 1 can be further provided with an image processing unit, an image forming unit and the like. The image processing unit performs image processing such as various kinds of corrections.

The image receiving unit 11 reads and accepts the photographic image data 100 from a memory built in to a digital camera which contains data of pictures taken with the digital camera by a customer, removable media storing the photographic image data 100 taken by the digital camera and the like.

Alternatively, the image receiving unit 11 may receive the photographic image data 100 forwarded from reception devices 3 connected to the network 2. The reception device 3 employs a reception apparatus installed in the store to read the photographic image data 100 taken by digital cameras from the memory built in to the digital cameras brought to the store or removable media, and to forward the photographic image data 100 through VPN, dedicated lines, and the like. Other than the reception apparatus installed at the store, a personal computer, a portable terminal, a mobile phone and the like can be used. More specifically, there are reception apparatuses which forward the photographic image data 100 from the terminals of digital cameras, personal computers and mobile phones using wireless LAN Internet connection (known as Hot Spot), from mobile phone services such as i-mode and J-SKY among mobile phones through the Internet, and from home personal computers through the Internet.

In order to reduce the read-out time and to prevent duplicate storage, the image receiving unit 11 does not read out the photographic image data 100 which has been already read out, but reads only the photographic image data 100 which has not already been read out. The image receiving unit 100 determines whether the photographic image data 100 has been already read out by, for example, comparing the file name of the photographic image data 100 to be read with the file names stored in the image storage unit 12, by confirming whether the photographic image data 100 has already been read out by attaching “already read out” information which notifies previous reading, and comparing a photography date with a previous read out date. When comparing the file names, invariable file names which the customers cannot change are used for management, besides user variable filenames which the customers can change. In addition, because the received photographic image data sets are managed for each customer, customer data, related to the customer from whom the photographic image data sets were received, is recorded in the image storage unit 12 along with the photographic image data sets.

The image storage unit 12 is a data base which accumulates and stores the photographic image data 100 (hereinafter, the image storage unit is referred to as an image data base). Moreover, it is possible provide the customers with a variety of photo services through the stored photographic image data 100. For example, each customer can browse, retrieve and download the photographic image data 100 through reception apparatuses, personal computers, portable terminals, mobile phones and the like. The customers can place an order of the photographic image data 100 to be printed, output the photographic image data 100 to a storage medium such as a DVD and transfer the data to a designated address. The variety of services can be provided, for example, through a website by installing a Web server at a service center.

The photographic image data 100 can be classified into groups designated by the customers so that the photographic image data 100 are classified into, for example, categories such as travel and growth record according to the customers' preferences.

The image storage expiration determining unit 13 determines whether to expire the storage period of the photographic image data 100 which satisfies a certain condition. The expired photographic image data 100 is recorded onto the storage recording unit 14. The expiration of the storage period is determined by conditions including: termination of storage period, the number of stored images has reached the predetermined number; and the used capacity of the server has reached the predetermined capacity. If the expiration of the storage period is determined for each aforementioned classified photographic image data 100, the storage recording medium 140 such as a DVD can be created for each theme.

Examples of the storage recording unit 14 are a DVD recording device and a memory recording device. When the storage recording unit 14 receives the judgment of storage expiration from the image storage expiration determining unit 13, the storage recording unit starts to record the expiring photographic image data 100 onto a storage recording medium 140 such as a DVD and a Smart Media™.

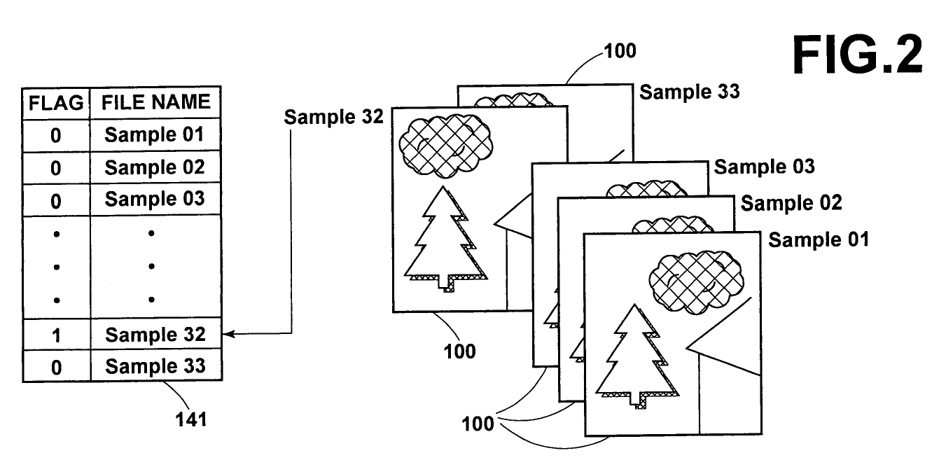

Now, during replay of associated images including similar scenes, the customers may want to confirm the contents of the associated images by viewing the representative image among them. Thereupon, the storage recording unit 14 stores a plurality of related photographic image data 100 such as similar scenes by associating the plurality of related photographic image data 100 and designating representative photographic image data 100 from among the plurality of related photographic image data 100. Accordingly, the storage recording unit 14 reproduces only the representative photographic image data 100 to enable the customer to select the representative photographic image data during replay. Furthermore, selection of the representative photographic image data 100 enables the photographic image data 100 of the similar scenes to be reproduced. For example, as shown in FIG. 2, an association table 141 is created, for associating “sample 01” to “sample 33” of similar photographic image data 100. By designating sample 32 as representative photographic image data 100, a flag represents “1” to indicate that sample 32 is the representative photographic image data. Accordingly, the storage recording unit records the photographic image data 100 as well as the association table 141 onto a storage recording medium 140. The association table 141 enables the photographic image data 100 of other similar scenes to be reproduced when the representative photographic image data is selected for replay. Herein, similar scenes are described. However, the association is not limited to the similar scenes, and associations can be made among images related to categories such as travel or growth record.

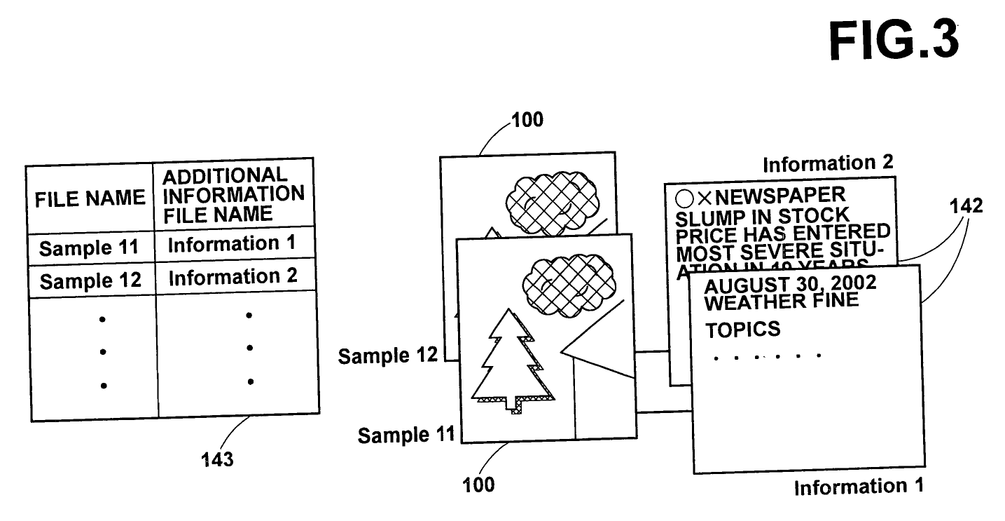

When the storage recording unit 14 records the photographic image data 100 onto the storage recording medium 140, the photographic image data 100 as well as additional information related to the images may be recorded onto a storage recording medium 140. For example, as shown in FIG. 3, the association table 143 associates the photographic image data 100 and additional information 142 to be recorded. The additional information 142 such as geographic information including names of places and buildings from GPS data, descriptions thereof, date information and information on current events can be obtained through the contents provided by a content provider 5 on the Internet.

Next, a printing unit 15 prints an index print of the photographic image data 100 recorded onto the storage recording medium 140. The index printing is performed by selecting the representative photographic image data, the photographic image data 100 with a constant frame interval, the photographic image data 100 in which several displayable frames are selected from all the frames, the photographic image data 100 related to photography dates in which frames are arranged according to the photography dates, the photographic image data 100 selected from the same photography date, or the like. If the customer's address is read out of the photographic image data 100 and printed along with the index print, the storage recording medium 140 and the index print can be mailed to the customer as a set.

Furthermore, the expired photographic image data 100 is recorded onto the storage recording medium 140. Thereafter, the data is deleted from the image database 12. At this time, defects possibly occur when the data is written onto a DVD. Thus, the photographic image data 100 may be deleted after stored for a predetermined period of time in a state where the customers cannot utilize the photo service.

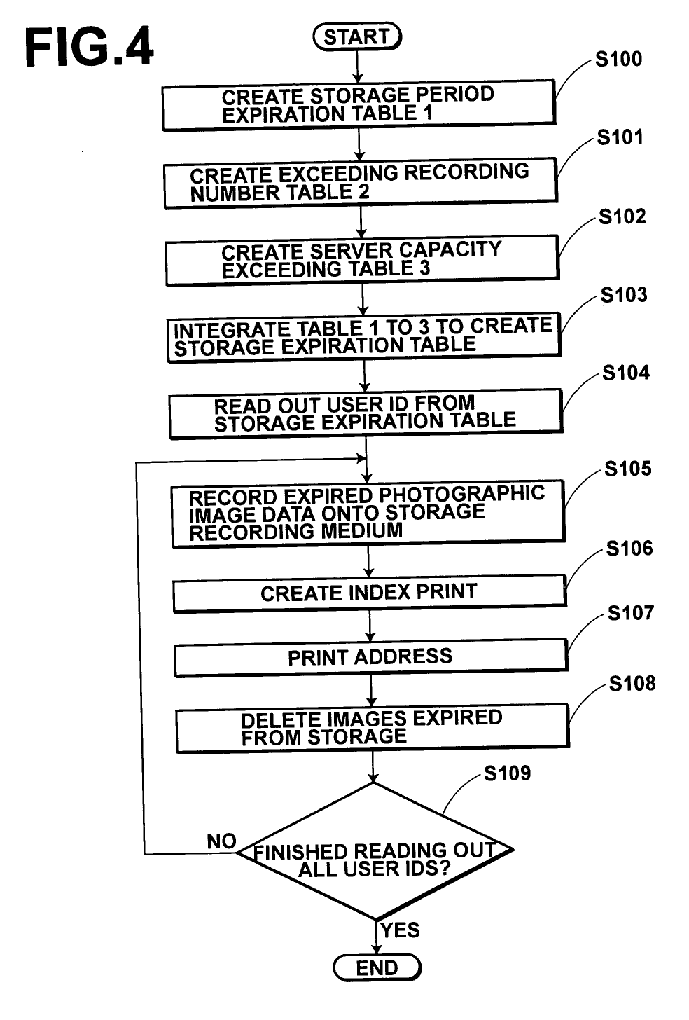

Next, the operation of the image management device 1 is described for when the expired photographic image data 100 is recorded onto a storage recording medium 140 using a flowchart shown in FIG. 4. Hereafter, a case where a DVD is used for the storage recording medium 140 is described.

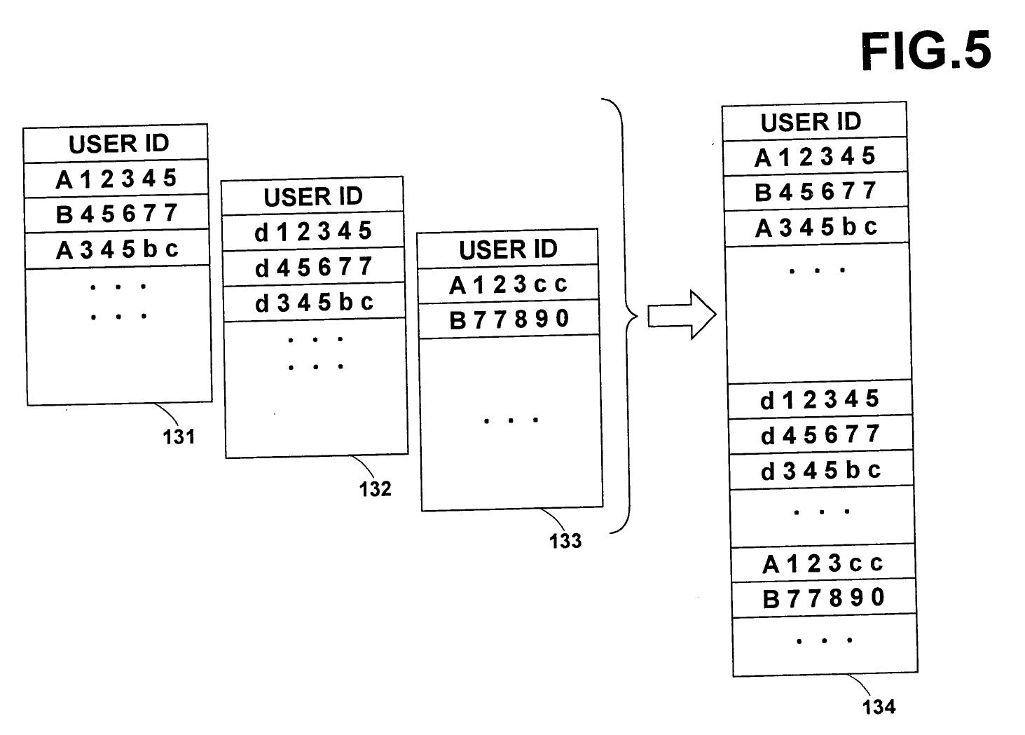

As shown in FIG. 5, the image storage expiration determining unit 13 creates a storage period expiration table 131 (S100), an exceeding recording number table 132 (S101) and a server capacity exceeding table 133 (S102). The storage period expiration table 131 manages the customers whose storage period expires. The exceeding recording number table 132 manages the number of photographs exceeding the predetermined number of records. The server capacity exceeding table 133 monitors whether the capacity of the photographic image data 100 has exceeded the predetermined server capacity. The storage period expiration table 131, the exceeding recording number table 132, and the server capacity exceeding table 133 are integrated to create a storage expiration table 134, which is a list of customers with the expired photographic image data 100 (S103).

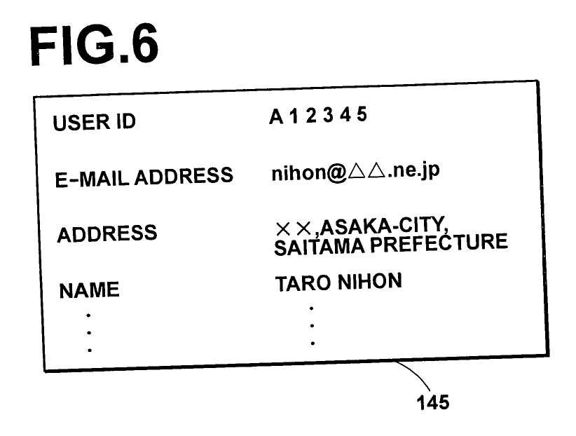

The expired photographic image data 100 is read out from the storage expiration table 134 for each customer ID (S104), and a record starting signal is sent to a DVD recording device 14 so that the read out photographic image data 100 is recorded onto a DVD 140 (S105). A printing device 15 prints an index print of the photographic image data 100 recorded onto the DVD 140 (S106). Furthermore, an address included in user information 145 in a customer database as shown in FIG. 6 is read out based on the customer ID, and address printing is performed (S107). Thereafter, the expired photographic image data 100 is deleted from the image database 12 (S108). Steps S105 to S108 are repeated until the foregoing steps for all the user IDs are completed.

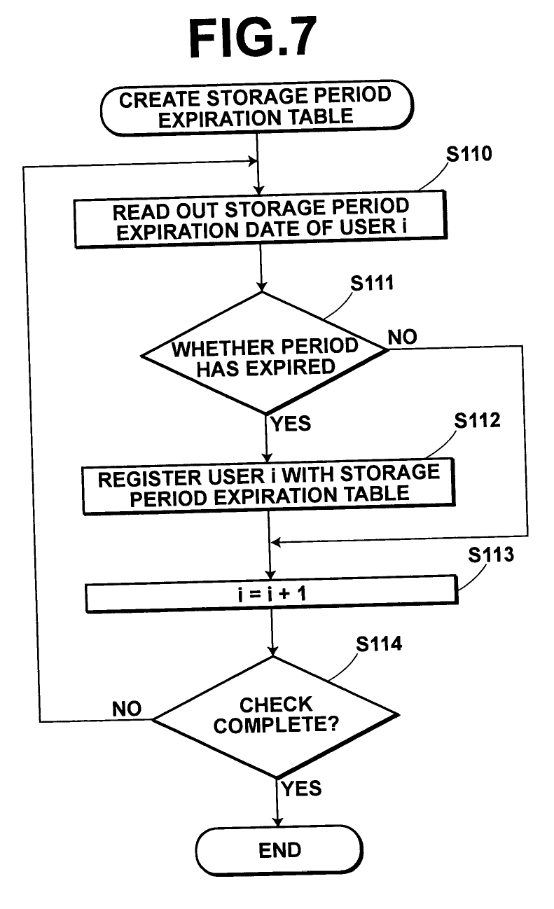

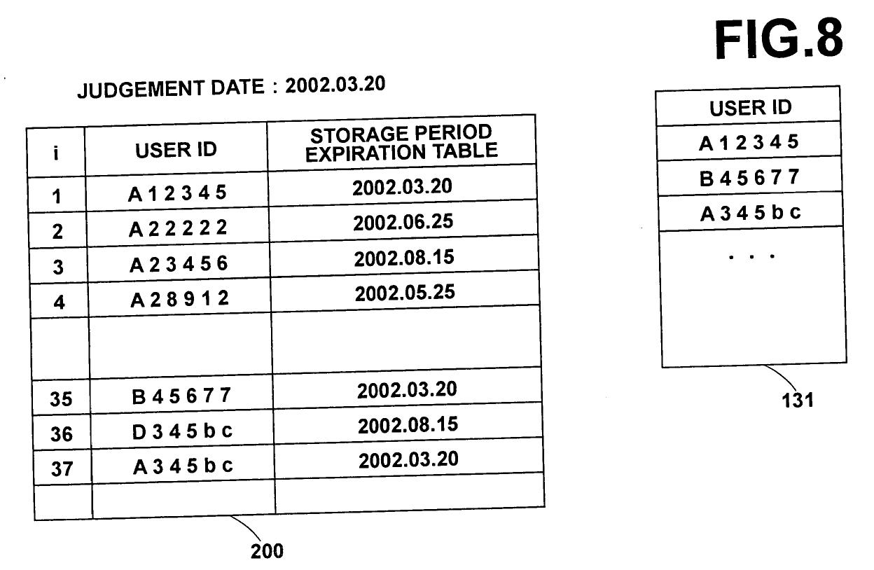

Herein, a method of creating the storage period expiration table 131 is detailed using a flow chart shown in FIG. 7. As shown in FIG. 8, a storage period expiration date of a user (i) is read out from a user management table 200 (S110). If the storage period of the user (i) is expired based on a determination date (S111-YES), the user ID of the user (i) is registered to the storage period expiration table 131 (S112). If the user is not expired, the user ID is not registered (S111-NO). Thereafter, the value of i is incremented by one (S113), and the next user is checked to determine whether his storage period has expired (S114-NO). When all the customers are checked, the steps are terminated (S114-YES). The exceeding recording number table 132 and the server capacity exceeding table 133 are created likewise.

Herein, a case has been described wherein the storage expiration is determined based on the storage period expiration table 131, the exceeding recording number table 132 and the server capacity exceeding table 133 together. However, the storage expiration can be determined based on any one of the tables.

The foregoing image management device is defined as a server computer. However, the image management device can be constituted of a combination of a plurality of computers and devices.

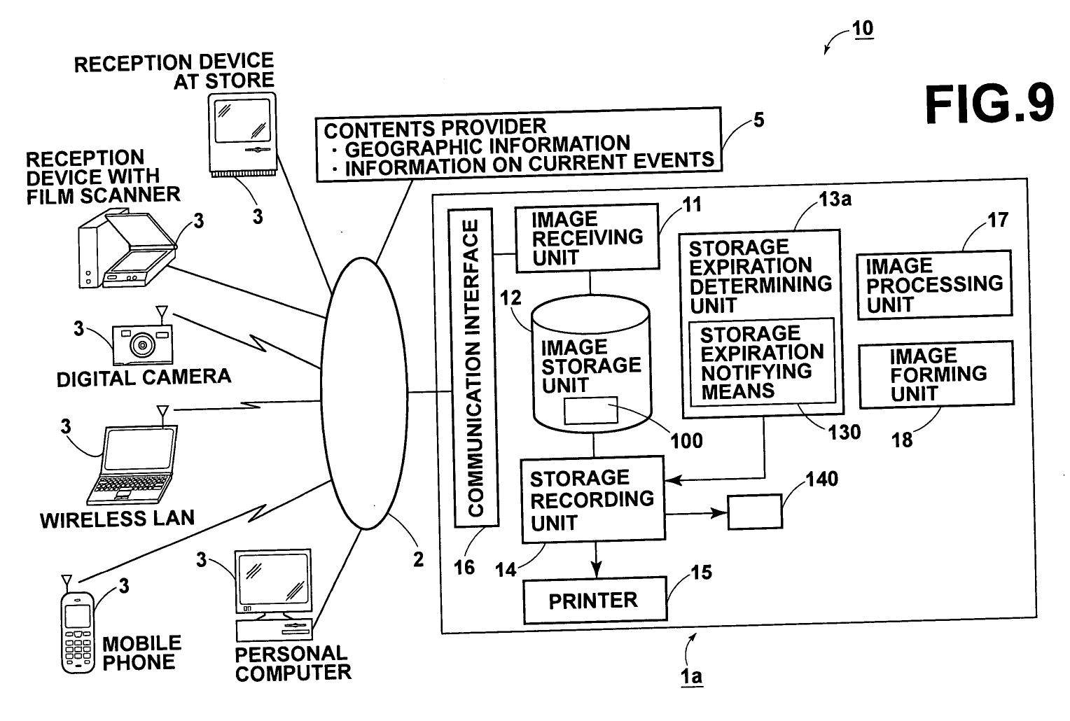

Next, an image management system 10 according to the second embodiment of the present invention is described using FIG. 9. The image management system 10 is explained for a case where the storage expiration is notified to the user terminals 4 such as personal computers, portable terminals, mobile phones and the like connected to the image management device 1a through the network 2. In addition, the same reference numerals are used for corresponding parts of the aforementioned image management device 1. Thus, detailed descriptions are omitted, and only the different parts are described.

The user terminals 4 can be connected to the Internet through Internet connections from personal computers, portable terminals and the like, mobile phone services such as i-mode and J-SKY from mobile phones, and CATV networks and dial-up connections from home personal computers. Additionally, the user terminals 4 have functions such as sending and receiving e-mails and browsing web pages by use of Web browsers.

The image management device 10 of the image management system 10 includes a storage expiration notifying unit 130 which notifies the user terminals 4 of storage expiration of the photographic image data 100. Herein, the photographic image data 100 is determined to be expired by the image storage expiration determining unit 13a. Furthermore, the customers may respond whether to record the data onto a DVD 140 or request the extension of the storage upon receipt of the notification.

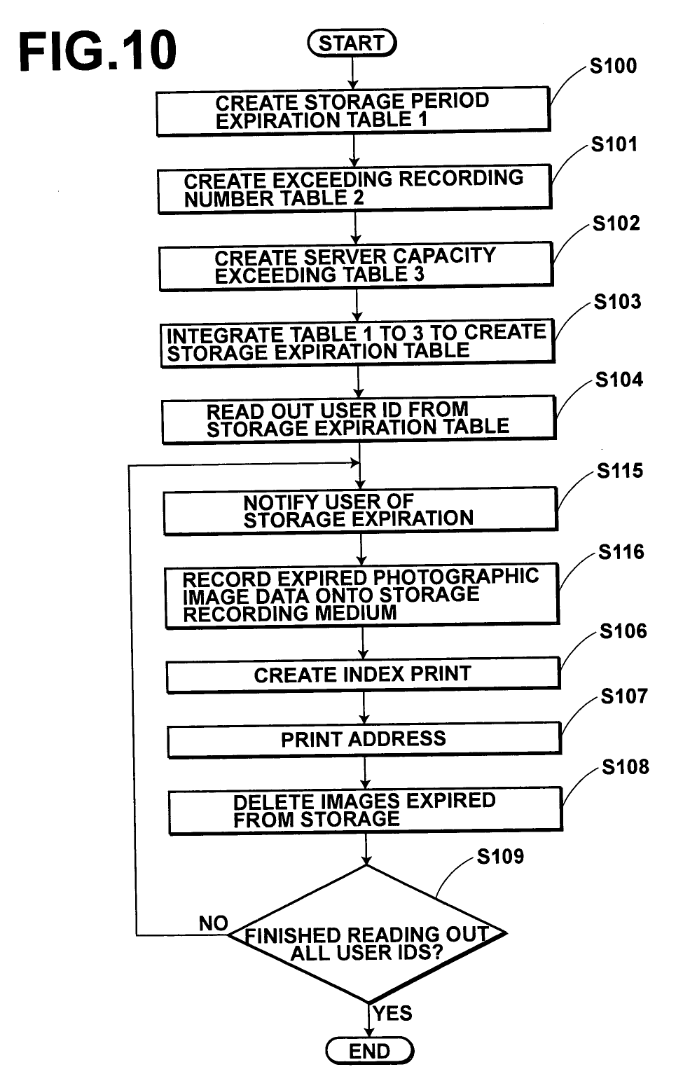

The operations of the image management device 1, when the photographic image data for which storage has expired is recorded onto a storage recording medium 140, are described using a flowchart shown in FIG. 10.

A storage expiration table 134 is created with Steps S100 to S103, which are similar to the steps explained in the flowchart of FIG. 4. Thereupon, an expiring user ID is read out from the storage expiration table 134 (S104). The e-mail address of the user is read out from the user information 145 of the user database shown in FIG. 6 based on the user ID, and the storage expiration is notified through an e-mail (S115). Furthermore, a recording start signal is sent to the DVD recording device and recorded onto a DVD 140 (S116). Since the steps after S106 are the same as the case explained using the flowchart in FIG. 4, detailed descriptions thereof are omitted.

As described above, the case where the customers are notified using e-mails is explained. However, the customers may be notified using Web pages.

In addition, photographs which were photographed while with a group of people may be desired to be viewed not only by the customer who stored the photograph, but by other people who were in the group. Therefore, for example, the customer who stored the photographs may display the stored photographic image data sets 100 on a web page by connecting the user's terminal 4 to the image management device 1a. Then, the user specifies other customers who have permission to view the photographic image data sets 100. The customer ID's or the like of customers who have permission to view the photographic image data sets 100 are attached to the photographic image data sets 100 in the image storage unit 12, thus enabling customers having the customer ID's specified as having permission to view the photographic image data sets 100 to do so.

In this case, the storage expiration notifying unit 130 checks whether photographic image data sets 100 for which a storage period is about to expire have customer ID's of customers who have permission to view them attached thereto. Based on the customer ID's, user information 145 is searched in the customer database, and the customers are notified of expiration of storage.

By notifying the customers as described above, the customers can request the extension of the storage period or the creation of a DVD. Thus, it is possible to improve the service for the customers.

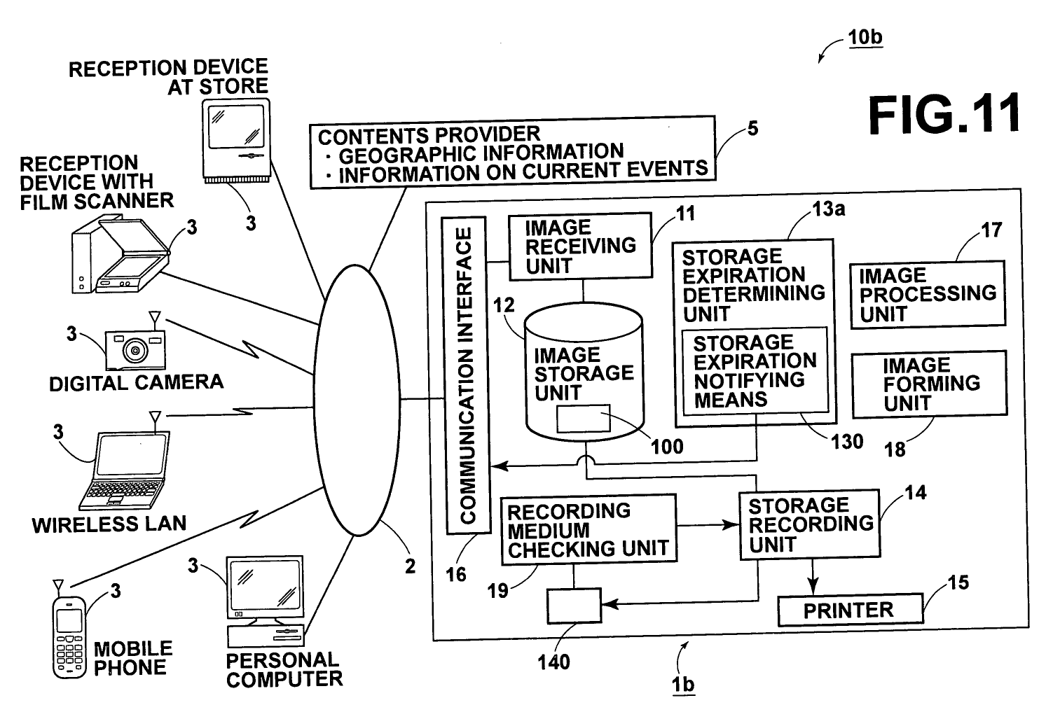

Next, an image management system 10b, according to the third embodiment of the present invention, will be described with reference to FIG. 11. In the third embodiment, a case will be described in which additional photographic image data sets are recorded onto a recording medium in which a customer's photographic image data sets are already recorded. Note that components having the same functions as the previously described embodiment will be denoted by the same reference numerals, and detailed descriptions thereof will be omitted. A description will be given only on the components that differ.

An image management device 1b of the image management system 10b comprises a recording medium checking unit 19 for checking customer data recorded in a storage recording medium 140, which is set in a storage recording unit 14, against customer data of photographic image data sets 100, for which a storage period has expired, to be recorded onto the storage recording medium 140 from an image storage unit 12.

Here, the flow of operations which occurs when photographic image data sets 100, for which a storage period has expired, are additionally recorded onto the storage recording medium 140, will be described.

First, a storage expiration notifying unit 130 notifies a customer that a storage period has expired, via an e-mail message or the like. The notified customer sends a storage recording medium 140 in his possession, in which photographic image data sets 100 are already recorded, to a service provider via mail or the like.

A customer ID, for example, is recorded in the storage recording medium 140 as customer data, during previous recording of the photographic image data sets 100 by the storage recording unit 14.

Then, the recording medium checking unit 19 checks the customer ID recorded in the storage recording medium 140 against a customer ID of the photographic image data sets 100 which are to be recorded in the storage recording medium 14. In the case that the two customer ID's match, the storage recording unit 14 additionally records the photographic image data sets 100, for which a storage period has expired, onto the storage recording medium 140.

In a similar manner as in the previously described second embodiment, in the case that customers other than the customer who stored the photographic image data sets 100 have permission to view them, the storage expiration notifying unit 130 transmits notification of the expiration of the storage period via an e-mail message or the like, by searching for user information 145 in a customer database, based on the customer ID's. The storage recording unit 14 enables additional recording of the photographic image data sets 100, if the customer ID of the storage recording medium 140 is that of a customer who has permission to view the photographic image data sets 100.

By enabling additional recording onto storage recording mediums in this manner, additional recording onto recording mediums having spare capacity is enabled, thereby eliminating waste thereof. In addition, because the customer data of the storage recording medium is confirmed prior to recording, photographs belonging to a third party are not mistakenly recorded on a customer's storage recording medium.

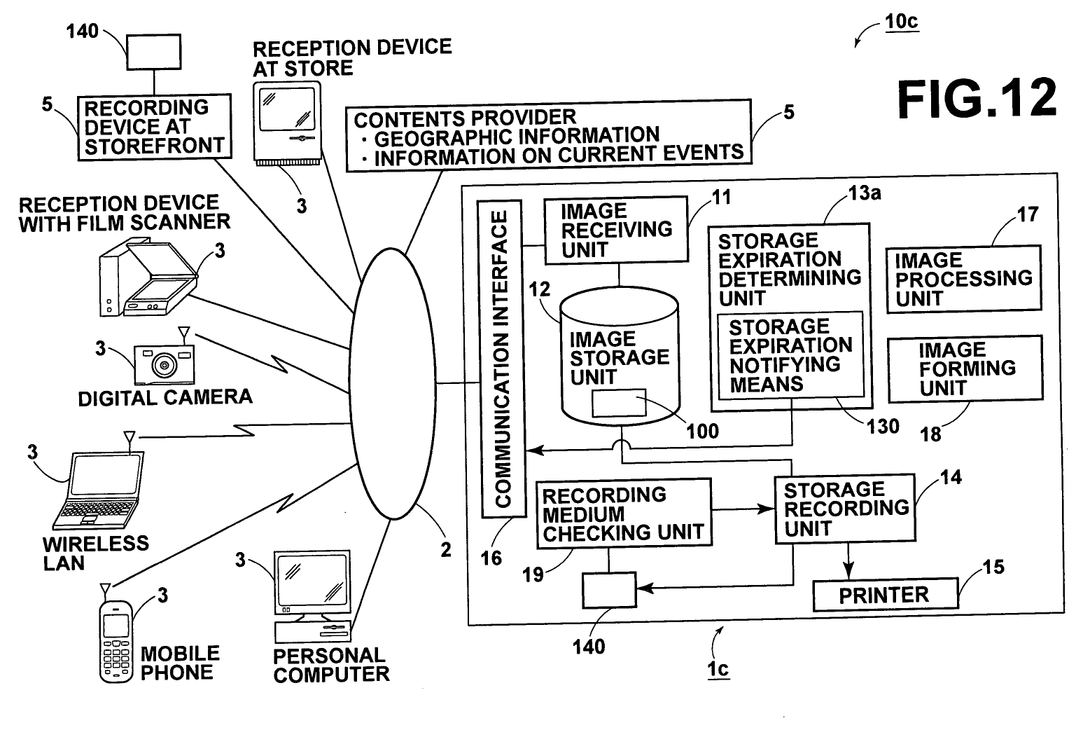

An image management system 10c according to the fourth embodiment of the present invention will be described with reference to FIG. 12. The case in which a storage recording medium is sent to a service provider to record photographic image data sets for which a storage period has expired using a recording medium recording apparatus of the service provider was described in the third embodiment. However, in the fourth embodiment, the case in which recording onto the storage recording medium is performed with a recording medium recording apparatus installed at a storefront will be described.

Note that components of the system that have the same functions as the previously described embodiments are denoted by the same reference numerals, and detailed descriptions thereof are omitted. Descriptions will only be given on the components that differ.

An image management device 1c of the image management system 1c comprises a communication interface 16; a storage recording unit 14c; and a recording medium checking unit 19c. The communication interface 16 is connected to a recording medium recording apparatus such as a DVD recording apparatus and a memory recording apparatus installed at a storefront. The storage recording unit 14c issues commands to the recording medium recording apparatus to record photographic image data sets 100 onto a storage recording medium 140. The recording medium checking unit 19c checks customer data recorded in the storage recording medium 140, which is set in the recording medium recording apparatus, against customer data of photographic image data sets 100 to be recorded onto the storage recording medium 140.

Here, the flow of operations will be described when photographic image data sets 100, for which a storage period has expired, are recorded onto a storage recording medium 140 by a recording medium recording apparatus installed at a storefront.

When a customer receives notification of expiration of storage via an e-mail message or the like, he brings a storage recording medium 140 to a storefront. The customer sets the storage recording medium 140 in the recording medium recording apparatus installed at the storefront, and performs a predetermined operation. A request for photographic image data sets 100 for which a storage period has expired is transmitted to the image management device 1c. When the image management device 1c receives this request, the recording medium checking unit 19c checks customer data of the storage recording medium 140, which is set in the recording medium recording apparatus installed at the storefront, against customer data of the photographic image data sets 100 to be recorded onto the storage recording medium 140. In the case that the customer data match, the storage recording unit 14c transmits the photographic image data sets 100, to be recorded onto the storage recording medium 140, to the recording medium recording apparatus at the storefront, and additional recording is performed onto the storage recording medium 140 that the customer has brought thereto.

In a similar manner as in the third embodiment, the storage recording medium 140 may be that of a customer who stored the photographic image data sets 100, or that of a customer who has permission to view the photographic image data sets 100.

In addition, the recording medium recording apparatus is not limited to that installed at a storefront. Alternatively, a PC in a customer's home may be provided with a recording medium recording apparatus such as a DVD recording apparatus and a memory recording apparatus. In this case, dedicated software fro recording photographic image data sets 100 into a storage recording medium 140 maybe installed in the PC; the photographic image data sets 100 downloaded via a network such as the Internet, and recorded onto the storage recording medium 140.

By enabling recording at a storefront or at home in this manner, additional recording onto a storage recording medium can be performed easily, without sending the storage recording medium to a service provider. Thus, the service provided to the customer can be improved.

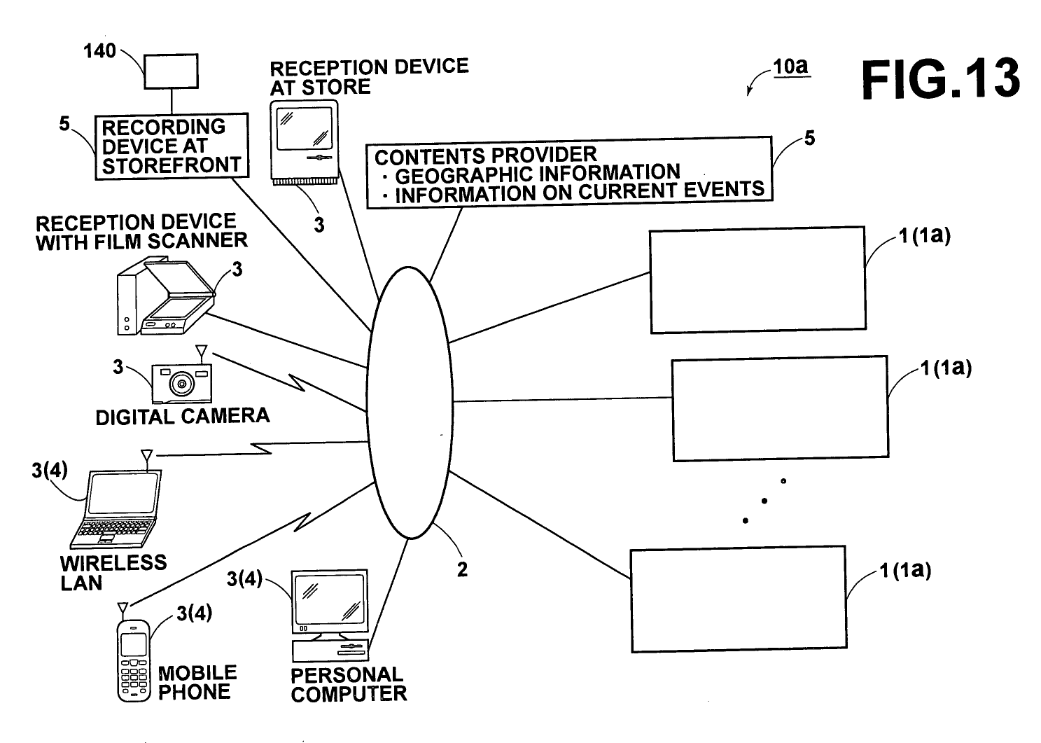

Next, an image management system 10a according to the fifth embodiment of the present invention will be described with reference to FIG. 13. As shown in FIG. 13, the image management system 10a includes a plurality of image management devices 1 (1a), and photographic image data 100 is accumulated and stored in a specific image management device 1 (1a). Moreover, detailed descriptions are omitted for the devices which are the same as the aforementioned image management devices 1 and 1a, and only the different parts are described.

A image receiving unit 11 transfers and stores received photographic image data 100 according to storage information regarding a storage location attached to the photographic image data 100. The address of the image management device 1(1a), to which the photographic image data 100 is stored, is automatically determined by codes pre-registered within digital cameras, pre-registered codes in digital cameras transferred to a removable medium, IDs registered with customers' cards and the like. For example, a transferring server computer address is determined by type codes of digital cameras, manufacturing number codes, owner codes of digital cameras or the like. For example, a TCP/IP address of the image management device 1 (1a) is determined by type codes of digital cameras, manufacturing number codes, owner codes of digital cameras or the like, and the photographic image data 100 is transferred.

In this way, it is possible to store the photographic image data 100 of the same digital cameras or removable medium in the same server computer. Alternatively, the photographic image data 100 can be stored in the same server computer for each customer.

Furthermore, as explained in the image management system 10, the storage expiration can be notified to the user terminals through e-mails or the like.

What is claimed is:

1. An image management device, comprising:
an image storage unit which accumulates and stores a plurality of photographic image data sets;
an image receiving unit which receives the plurality of photographic image data sets from customers and stores the plurality of photographic image data sets, along with customer data related to the customers, in a state accessible to the customers;
an image storage expiration determining unit which determines whether to expire from storage the plurality of photographic image data sets accumulated and stored in the image storage unit; and
a storage recording unit which records the plurality of photographic image data sets determined to be expired from storage by the image storage expiration unit onto a storage recording medium which can be returned to the customers.

2. The image management device according to claim 1, wherein the image receiving unit determines whether a received photographic image data set, from among the plurality of received photographic image data sets, has been already received before, based on additional information attached to the photographic image data set, and receives only photographic image data sets which have not been received yet.

3. The image management device according to claim 1, wherein the image receiving unit transfers and stores the plurality of received photographic image data sets in the image storage unit through a network.

4. The image management device according to claim 1, wherein the image storage expiration determining unit determines storage expiration for each pre-classified photographic image data group.

5. The image management device according to claim 1, wherein the storage recording unit records the plurality of photographic image data sets onto the storage recording medium so that associated photographic image data sets can be reproduced, by: associating the plurality of photographic image data sets; designating a representative photographic image data set from among the associated plurality of photographic image data sets; and selecting the representative photographic image data set during reproduction.

6. The image management device according to claim 1, wherein the storage recording unit associates and records photographic image data sets and additional information, related to the photographic image data sets, onto the storage recording medium.

7. The image management device according to claim 1, wherein the image storage unit stores the plurality of photographic image data sets, which have been recorded onto the storage recording medium, for a predetermined period of time in a state where the customers cannot access the plurality of photographic image data sets, and thereafter, deletes the plurality of photographic image data sets from the image storage unit.

8. The image management device according to claim 1, further comprising a printing unit which prints an index print of the plurality of photographic image data sets when the plurality of photographic image data sets are recorded onto the storage recording medium.

9. The image management device according to claim 8, wherein the printing unit includes selecting means for selecting desired photographic image data sets from among the plurality of photographic image data sets recorded onto the storage recording medium, and the index print is created for only the photographic image data sets selected by the selecting means.

10. The image management device according to claim 1, further comprising a checking unit for checking customer data recorded in the storage recording medium against the customer data stored along with the image data sets accumulated in the image storage unit, when additional image data sets are to be recorded into the storage recording medium in which image data sets of a predetermined customer are already stored by the storage recording unit; wherein
the storage recording unit records the image data sets for which the customer data checked by the checking unit match, in the storage recording medium.

11. An image management system which connects user terminals and an image management device through a network, in which the image management device has an image storage unit which accumulates and stores a plurality of photographic image data sets; an image receiving unit which receives the plurality of photographic image data sets from customers and stores the plurality of photographic image data sets in a state accessible to the customers, along with customer data related to the customers; an image storage expiration determining unit which determines whether to expire from storage the plurality of photographic image data sets accumulated and stored in the image storage unit; and a storage recording unit which records the plurality of photographic image data sets determined to be expired from storage by the image storage expiration unit onto a storage recording medium; wherein
the image storage expiration determining unit includes storage expiration notifying means for notifying the user terminals of storage expiration of the plurality of photographic image data sets, which have been determined to be expired.

12. The image management system according to claim 11, wherein the storage expiration notifying means further notifies the user terminals of customers who have permission to view the plurality of photographic image data sets, of storage expiration of the plurality of image data sets which have been determined to be expired.

13. An image management system as defined in claim 11, wherein the storage recording unit records onto the storage recording medium via a network.

14. An image management system as defined in claim 12, wherein the storage recording unit records onto the storage recording medium via a network.

15. An image management system which connects a plurality of image management devices through a network, in which the image management device has an image storage unit which accumulates and stores a plurality of photographic image data sets; an image receiving unit which receives the plurality of photographic image data sets from customers and stores the plurality of photographic image data sets in a state accessible to the customers, along with customer data related to the customers; an image storage expiration determining unit which determines whether to expire from storage the plurality of photographic image data sets accumulated and stored in the image storage unit; and a storage recording unit which records the plurality of photographic image data sets determined to be expired from storage by the image storage expiration unit onto a storage recording medium; wherein
the plurality of photographic image data sets have attached thereto storage information, which specifies a predetermined storage location of the photographic image data for a digital camera or the customers; and
the image receiving unit transfers the plurality of photographic image data sets to a predetermined image management device according to the storage information of the plurality of received photographic image data sets and stores the plurality of photographic image data sets in the image storage unit of the image management device.

16. The image management system according to claim 15, wherein:
the image storage expiration determining unit includes storage expiration notifying means for notifying the user terminals of storage expiration of photographic image data sets determined to be expired.

17. The image management system according to claim 16, wherein the storage expiration notifying means further notifies the user terminals of customers who have permission to view the plurality of photographic image data sets, of storage expiration of the plurality of image data sets which have been determined to be expired.

18. The image management system according to claim 16, wherein the storage recording unit records onto the storage recording medium via a network.

19. The image management system according to claim 17, wherein the storage recording unit records onto the storage recording medium via a network.
